(19) United States
(12) Patent Application Publication
(10) Pub. No.: US 2006/0042851 A1
(43) Pub. Date: Mar. 2, 2006

(54) Passenger-protection device in a vehicle

(76) Inventors: Thomas Herrmann, Oehringen (DE); Thomas Engelberg, Hildesheim (DE); Stephan Spaeth, Ludwigsburg (DE)

Correspondence Address: KENYON & KENYON, ONE BROADWAY, NEW YORK, NY, 10004, US

(21) Appl. No.: 11/210,938

(22) Filed: Aug. 23, 2005

(30) Foreign Application Priority Data
Sep. 2, 2004 (DE) 10 2004 042 959.6

(51) Int. Cl. B60K 28/00

(52) U.S. Cl. 180/271

(57) ABSTRACT

A passenger-protection device with a passenger-protection unit in a vehicle, having at least one sensor, is provided, which detects the movement of at least one body part of the passenger in the vehicle. Furthermore, an evaluation unit for triggering a passenger-protection unit in the vehicle is provided, the passenger-protection unit being triggered as a function of the detected movement of the at least one body part.

### FIELD OF THE INVENTION

The invention relates to a passenger-protection device in a vehicle.

### DESCRIPTION OF RELATED ART

Vehicular passenger-protection devices which protect a passenger in a collision of the vehicle to reduce the effects of an accident are not new. Especially so-called airbags in which an air cushion is inflated by a propellant charge to cushion a passenger in a collision are known as passenger-protection units. Furthermore, systems for belt tightening are known as well which tighten a safety belt in a collision in an attempt to keep the driver in position. The protective devices are used particularly to prevent the driver from colliding with vehicle components and also to restrict an acceleration acting on the driver. It is also known to provide headrests on the driver seat in this context. So-called crash-active headrests are known to this end which adjust the position of the headrest in the event of a collision, the headrest being moved forward, in particular. A collision is generally ascertained in that acceleration sensors are installed in the vehicle which are able to detect a sudden acceleration or deceleration of the vehicle. The aforementioned passenger-protection units are triggered as a function of the detected acceleration. The triggering is controlled via a seat mat, for example, in such a way that only the safety devices on seats in the vehicle will be activated that are actually occupied by a passenger who may benefit from the triggering of the individual safety device.

### SUMMARY OF THE INVENTION

In contrast to the related art, the passenger-protection device according to the invention has the advantage that a movement of at least one body part of the passenger in the vehicle is detected by a passenger-compartment sensor. While a measurement by acceleration sensors is able to detect only the accelerations acting on the vehicle, the passenger-protection device according to the invention is able to adapt the response of a passenger-protection unit to the actual body movements in that the body movement, at least the body movement of at least one body part, is detected directly and analyzed for the triggering of the passenger-protection unit. This makes it possible to adapt both the trigger instant of a passenger-protection unit and a spatial response or spatial adjustment of a passenger-protection unit to the passenger's actual movement sequence in the event of a collision. While the acceleration values must be established in a vehicle-specific manner in order to ensure a correct evaluation, the analysis of a movement of a passenger's body part is able to be carried out independently of the vehicle. This reduces the implementation expense.

It is particularly advantageous to assign a memory unit to the evaluation device in which limit values for ascertaining critical movement sequences of the at least one body part are stored. Via a comparison with these limit values, it is possible to filter out random movement sequences that may be confused with a collision-related passive movement of the passenger or the individual body part. For instance, if the passenger's head is monitored, it is possible, via analysis of the movement sequence, for example, to reliably distinguish between abrupt head movements caused by sneezing or movements that are due an accident sequence. The evaluation of these stored data may preferably be combined with the evaluation of other sensors in the vehicle.

It is especially advantageous to record the head of the driver and to analyze the head movement since the cervical spine is particularly vulnerable in vehicular accidents. The passenger moving forward in a suddenly braked vehicle is caught by the belt. As a result of such restraining it may happen that the head is in turn thrown back in a kind of bouncing movement. While modern vehicles have a headrest to absorb the rearward movement of the head, overstretching of the cervical spine in a backward movement of the head may occur nevertheless as a result of a long acceleration path or possibly due to an incorrect adjustment of the headrest if the headrest is adjusted or positioned incorrectly or if it is too far away from the head. The acceleration forces acting on the cervical spine in this case may cause serious injuries. Because of the monitoring of the head and the adaptation of the passenger-protection unit according to the present invention, in particular the positioning of a headrest and/or backrest, the risks of an injury to the cervical spine are able to be reduced. Due to monitoring of the head by a passenger-compartment sensor inside the vehicle, a better response to an actual head movement is possible compared to a simple detection of acceleration values of the vehicle. Furthermore, a direct, driver-specific detection and analysis may be implemented in which the driver's height is taken into account.

A detection preferably using an optical sensor is implemented, the optical sensor recording a camera image and allowing the detection of a body movement by comparing camera images that are taken in time succession. Particularly advantageous is the use of a 3D camera, which produces depth images and thus allows the spatial measurement of the position and orientation of body parts and objects. However, it is also possible to arrange additional sensors in the vehicle interior, either as substitute or in addition. In particular capacitive sensors, which detect a change in the electric field, may be used as well, or ultrasonic sensors, which implement a distance measurement with respect to the individual body part by way of an echo method.

Furthermore, it is advantageous to provide a filter unit in which the previously determined position of the individual body part is detected so as to predict the location at which the body part will then be located in a new measurement. In addition to the position of the body part, a previously determined movement velocity of the body part will be considered here, in particular. This increases the accuracy of a detection and, in particular, speeds up the detection. If a prediction is made, in the case of an image comparison it will not be necessary to analyze the entire image, for instance, but a partial area of the image will preferably be analyzed first. If the body part in question is detected in this partial area, further analysis of the image may be dispensed with, if appropriate. This increases the detection speed of the passenger-protection device.

Moreover, it is advantageous to provide an evaluation unit by which the passenger-protection unit is triggered as a function of the ascertained height and/or weight of the passenger. In this way, it is possible to respond to the height or the weight of the passenger in a selective manner, so that suitable protective measures may be taken. For instance, the headrest may be adjusted to a predefined value as a function of the height. The charge pressure of the airbag or the belt tightening may be selected as a function of the height or weight of the passenger.

It is also advantageous that an activation of the passenger-protection unit is suppressed if no passenger is detected on the seat in the vehicle assigned to the sensor. This avoids an unnecessary triggering of the passenger-protection unit. In particular an unnecessary triggering of an airbag that may endanger a child in a child seat, for instance, or whose repair would be quite costly, is prevented. Furthermore, the unnecessary triggering of, for instance, a crash-active headrest is ruled out in a collision.

### BRIEF DESCRIPTION OF THE DRAWINGS

Exemplary embodiments of the invention are illustrated in the accompanying drawings and explained in greater detail in the following description.

The figures show:

FIG. 1 a first exemplary embodiment for a passenger-protection device according to the invention.

FIG. 2 an exemplary embodiment for a control unit of a passenger-protection device according to the invention.

FIG. 3 a sequence of a body movement of a passenger to elucidate the passenger-protection device according to the invention and the method according to the invention.

### DETAILED DESCRIPTION OF THE INVENTION

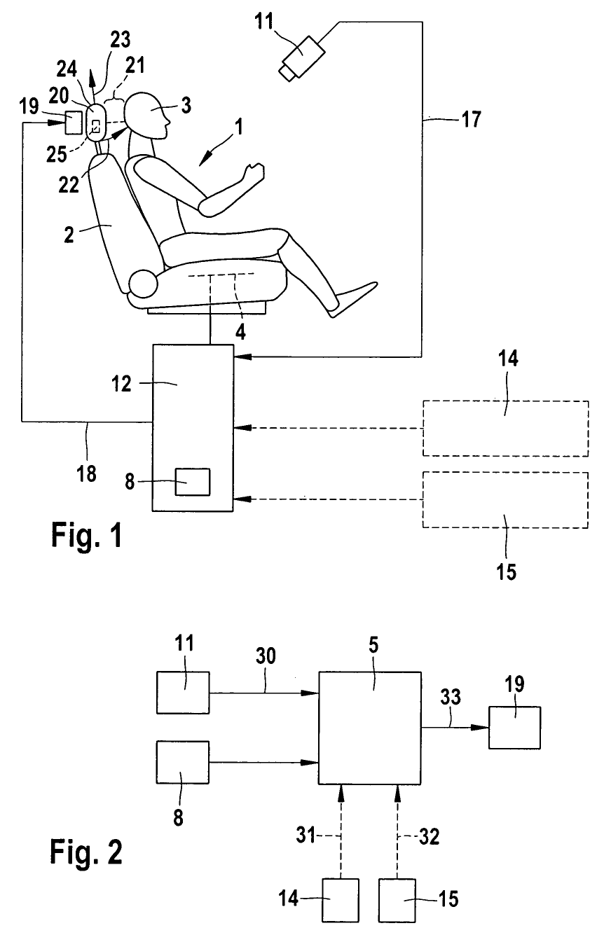

The passenger-protection device according to the invention may be used in a wide variety of motor vehicles. Especially advantageous is its use in motor vehicles in which high acceleration values may occur in the event of a collision, which may be reduced, however, by taking appropriate protective measures. According to the present invention, one or several body parts of the passengers are monitored by suitable sensors which are arranged in the vehicle interior, in particular. The monitoring is implemented by ascertaining a movement of these body parts. An acceleration at which the detected body parts move in the vehicle interior, is preferably ascertained from the movement. If a predefined acceleration limit is exceeded in the process, it must be assumed that the movement of the body part is not based on a movement that was controlled or caused by the passenger him/herself. Instead, a movement that was produced as a result of a sudden acceleration of the vehicle (for instance due to an impact to the vehicle rear) must then be assumed. Accidental body movements such as swatting at an insect or sneezing are excluded from the analysis in this manner. Slow decelerations due to a braking operation or an only slight collision of the vehicle may be excluded as well. However, if the vehicle is strongly decelerated and a very abrupt body movement occurs as a result, this will be detected in a reliable manner. Any body parts, for instance an arm, the upper torso or also the legs of the driver may be monitored. However, the passenger's head may be exposed to especially high accelerations relative to the upper body since the head itself is not restrained by the safety belt. Since it is mainly the head, and here the cervical spine, that is at an especially high risk of injury, hereinafter the invention will be elucidated using the example of a sensor for monitoring the head of a passenger in the vehicle. The term “passenger” must be understood to denote not only passive passengers riding in the vehicle, but also an actual driver steering the vehicle. A passenger-protection device of the invention is shown schematically in FIG. 1. A passenger 1 has taken a seat on seat 2 in the vehicle. The passenger is monitored by a sensor 11, which in one specific embodiment is configured as CMOS camera sensor. Sensor 11 is aligned such that it detects movements of the passenger in the head region, the shoulder region and the neck region. To this end, the sensor is configured as a video sensor generating a depth image. In a first specific embodiment, sensor 11 forwards image information to an evaluation unit 12 for further analysis. In a preferred specific embodiment, a first analysis of the image signals may also be carried out within sensor 11. For instance, the position of head 3 of passenger 1 may be ascertained by sensor 11. Furthermore, sensor 11 is configured to detect the height of passenger 1 and to forward it to evaluation unit 12. This will require a calibration of the sensor during installation in the vehicle. Moreover, sensor 11 may also detect an entire positioning of the upper body, so that not only the three-dimensionally determined head position but also a position of the upper body of passenger 1 are forwarded to evaluation unit 12. Furthermore, a seat occupancy may be detected electronically, via a seat mat 4, and be transmitted to evaluation unit 12. If no change in the seat occupation has been determined via seat mat, both variables—i.e., the head position and the body posture—are monitored over time.

In a preferred specific embodiment, evaluation unit 12 also receives data from one of a plurality of acceleration sensors 14 which are arranged inside the vehicle. Using acceleration sensor(s) 14, the decelerations are ascertained at least in the driving direction, but possibly also in other directions relative to the vehicle. If appropriate, additional sensors 15 in the vehicle may be analyzed as well. Additional sensors 15 may be, for instance, sensors for sensing the vehicle environment so as to detect obstacles approaching the vehicle, and to indicate a potential impact already prior to the occurrence of such an impact. Furthermore, impact sensors that detect a mechanical impact by interruption of an electrical contact, for example, may be provided as well.

Sensor 11 is preferably arranged on the vehicle roof, so that the head of the driver is able to be detected in a simple manner. In a first specific embodiment, sensor 11 is able to detect the position of the head in the visible range of the light. However, a detection in the infrared range using light is possible as well. In another specific embodiment, infrared illumination elements (not shown here) may also be arranged inside the vehicle for this purpose, so that the head of the passenger may be reliably detected even in the dark. Sensor 11 is connected to evaluation unit 12 via a data line 17. To reliably ascertain the way in which the head movement occurs, the head incline relative to the upper body as well is preferably detected over time.

Evaluation unit 12 has a memory unit 8 where critical movement sequences of the head or the body posture of the passenger are stored. In particular limit values for the acceleration of the head are stored here, such accelerations being detected on the basis of the recorded head movement. For instance, if an acceleration of the head is detected that is several times—in general three to eight times—higher than the gravitational acceleration, a collision will be assumed. However, a collision may also be assumed if the head is accelerated at a speed that is three to five times greater than the gravitational speed, and acceleration sensors 14 or additional sensors 15 in the vehicle detect a collision of the vehicle at the same time. The limit values for a corresponding acceleration are preferably stored in memory 8 as well.

If evaluation unit 12 ascertains a collision, it controls an actuating unit 19 via a data line 18, thereby moving a headrest 20 forward in such a way that a distance 21—indicated by a dashed line—between headrest 20 and head 3 is reduced, if possible. The movement of the headrest is indicated by an arrow 22. In a preferred specific embodiment an instant of the headrest movement is adapted to the movement of the head. This allows a reliable interception of the head by the headrest, thus avoiding, in particular, that the headrest acts on head 3 by an additional, harmful momentum. Furthermore, it is additionally ensured that the headrest will be available early enough to cushion head 3 and to reduce the acceleration acting on the head.

In a further preferred specific embodiment, actuating unit 19 is designed to adjust the height of the headrest as well, in such a way that, if appropriate, it is moved in arrow direction 23 or in the opposite direction (not shown) so as to adapt the height of the headrest to the position of the head. The position of the head, too, is preferably determined by sensor 11. Even if the driver has properly adjusted the headrest at the beginning of the ride, it is possible that his seating posture has changed while driving so that the headrest is no longer optimally positioned for him. The position of head 3 is therefore preferably analyzed in terms of ascertaining the height that must now be provided for the headrest in order to protect the passenger in an optimal manner in the collision. Evaluation device 12 analyzes the ascertained head position to be expected when head 3 and headrest 20 make contact, and adjusts headrest 20 to an optimal position. This prevents possible overstretching of head 3 beyond an upper side 24 of headrest 20. At the same time, it optimizes the contact area of head 3 relative to headrest 20. An adjustment angle of headrest 20 may be selected accordingly as well, so that a movement of headrest 20 in the direction of arrow 22 likewise occurs as a function of the movement of head 3.

In another specific embodiment, evaluation unit 12 analyzes acceleration sensors 14 and/or additional sensors 15 in such a way that a direction of the acceleration acting on the vehicle is taken into account. If a head movement is detected, these data are preferably utilized in addition in order to predict a likely further movement of the head, so that headrest 20 will be adjustable in an optimal manner. Various movement sequences, especially for impact processes acting on the vehicle from different directions, are stored in memory 8 for analysis.

Actuating unit 19 may be a motor-actuated actuating unit. In another specific embodiment an initial stress of the headrest may be predefined as well, the headrest being moved into the desired position by release of a holding mechanism such as a detent hook or a magnet, by the initial stress of a spring or a similar tensioning element. In another specific embodiment it is also possible to utilize an actuating unit (not shown in FIG. 1) to adapt the position of the backrest to a passenger's expected movement so as to provide optimal overall cushioning not only for the head but the entire upper torso of the passenger.

If the seat is not occupied or if the positioning of the headrest is unable to contribute to the protection of the individual passenger, for instance because the passenger is too small, an actuation of headrest 20 will be suppressed following a request by the analyzing unit.

Moreover, in a preferred specific embodiment, evaluation unit 12 also triggers additional passenger-protection units in the vehicle, for instance an airbag. In a corresponding manner, a side airbag or a headrest airbag may be triggered analogously as well.

FIG. 2 shows the processing of the incoming signals from evaluation unit 12 in more detail. A computing unit 5 processes signals 30, transmitted by sensor 11, of the movement sequence of the vehicle passenger's body part. The measured movement sequence is compared with reference movement sequences stored in memory 8, either continuously or as a function of a trigger signal. Memory 8 has a database of the reference movement sequences which preferably encompass characteristic passenger movements that are highly likely to result in an injury of the driver, in particular in cervical-spine acceleration trauma. Each reference movement sequence stored in memory 8 is assigned an optimal strategy for the triggering of systems so as to avoid cervical-spine acceleration trauma in a suitable manner. The triggering characteristic may be assigned to different sizes of individuals. Various person classifications are known to this end where individual specific standard sizes are assumed so as to facilitate an adjustment. However, it is also possible to make adjustments to specifically measured sizes.

Triggering may be implemented in particular by a trigger signal 31 transmitted by acceleration sensors 14, or by a trigger signal 32 transmitted by the additional sensors. Signals 31, 32 are preferably transmitted to computing unit 5 via a suitable data bus. Computing unit 5 has a threshold-value input where signals 31, 32 are compared with predefined threshold values, the triggering being implemented as a function of an exceeding of these threshold values. This prevents that strong braking or strong accelerations triggers a response by the passenger-protection unit. As a function of the acceleration sensors, computing unit 5 may select for comparison those movement sequences that result in the particular collision behavior to be expected. In a side collision, for instance, other curves may thus be selected for the comparison than in the case where the vehicle crashes into an obstacle or where another vehicle crashes into the vehicle while it is at a standstill. This increases the coordination and evaluation accuracy of the head movement and speeds up the processing since a comparison with only the actually relevant data is required. In accordance with an individually to be expected collision, and in accordance with the head movement to be expected, a trigger signal 33 for the triggering of the headrest is output to actuating unit 19. The particular triggering of headrest 20 that is assigned to an expected, stored movement sequence is implemented. In the process, the particular stored movement sequence that most optimally conforms to the measured movement sequence of the passenger will be utilized.

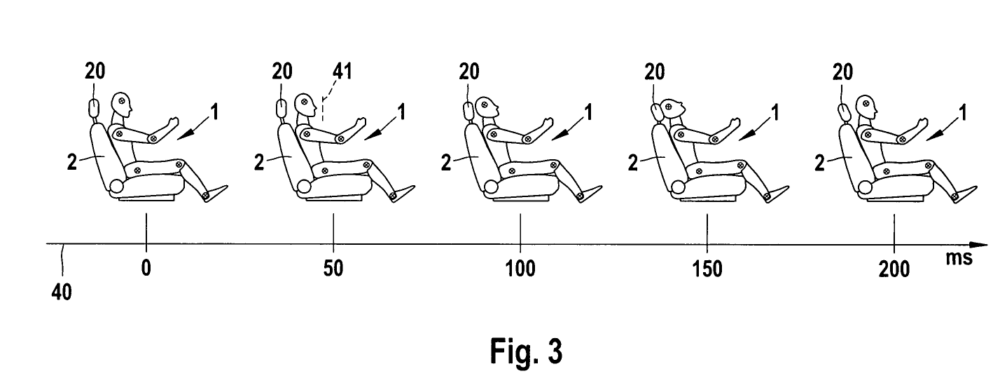

FIG. 3 illustrates a sequence of a typical reference-movement sequence which occurs in a rear collision of the other vehicle involved in a crash. Different states of the passengers' body posture are plotted above a time axis 40 for different times. For reasons of clarity, an actual movement state of the passenger is shown only at instants 0, 50 ms, 100 ms, 150 ms, 200 ms. The time scale has been selected in relation to a crash instant 0. However, a position determination of the passenger is preferably carried out every 5 ms. A resolution of the movement sequences at time intervals of 1 ms is preferably aimed for. Seat 2 and passenger 1 are both shown at the states assigned to the individual instants. As a result of the rear collision the head is moved backward, so that an impact on the headrest is expected. After 60 ms, the headrest is inclined in such a way that the path of the head toward the headrest is shortened by at least a few cm and the contact surface of the headrest relative to the head becomes larger. 150 ms after the impact, the distance between the head and the headrest is increased again. The headrest remains in the inclined position and may manually be reset to its original position after the collision, either by the driver or service station personnel. In another specific embodiment, actuating unit 19 may also be designed such that the headrest is automatically reset to the original position after the collision.

In the sequence illustrated in FIG. 3, it is possible to derive from the spatial change in the head position that between the 30 ms instant and the 60 ms instant an acceleration of the head that was at least eight times greater than the gravitational acceleration must have taken place. By an exceeding of this acceleration limit evaluation unit 12 triggers the tilting of headrest 20.

In another specific embodiment, sensor 11 may detect the position of the head continuously as well. For support, a distance sensor 25 may be integrated in the headrest by which an even more precise determination of the head position is possible. In a further specific embodiment, instead of a single sensor 11, a multitude of sensors which form a sensor field may be provided as well. This allows cross-measurements to be carried out, if appropriate, which allow an even more precise determination of the spatial position of the head.

At the 50 ms time entry, a region 41 near the driver's head is indicated by dashed lines. This region is considered the region in which the position of the head is to be expected now following recording of the head movement up to this point. In a subsequent evaluation by sensor 11, region 41 will be analyzed first in order to accelerate the analysis.

What is claimed is:

1. A passenger-protection device in a vehicle comprising:
at least one sensor (11) for recording a movement of at least one body part (3) of a passenger (1) in a vehicle, and an evaluation unit (5, 12) for triggering a passenger-protection unit (19, 20) as a function of the recorded movement of the at least one body part (3).

2. The passenger-protection device as recited in claim 1, further comprising a memory unit (8) assigned to the evaluation unit (12), the memory unit (8) storing critical movement sequences of the at least one body part or limit values for ascertaining critical movement sequences of the at least one body part (3).

3. The passenger-protection device as recited in claim 1, wherein the sensor (11) is configured to detect a movement of the head (3) of the passenger (1).

4. The passenger-protection unit as recited in claim 1, wherein the passenger-protection unit is configured as an actuating unit (19) for a headrest (20) or a backrest for adapting the position of the headrest (20) or the backrest, and the actuating unit (19) is triggered by the evaluation unit (12) in such a way that the position of the headrest (20) or the backrest is adapted to the detected movement of the at least one body part (3).

5. The passenger-protection unit as recited in claim 2, wherein the passenger-protection unit is configured as an actuating unit (19) for a headrest (20) or a backrest for adapting the position of the headrest (20) or the backrest, and the actuating unit (19) is triggered by the evaluation unit (12) in such a way that the position of the headrest (20) or the backrest is adapted to the detected movement of the at least one body part (3).

6. The passenger-protection unit as recited in claim 3, wherein the passenger-protection unit is configured as an actuating unit (19) for a headrest (20) or a backrest for adapting the position of the headrest (20) or the backrest, and the actuating unit (19) is triggered by the evaluation unit (12) in such a way that the position of the headrest (20) or the backrest is adapted to the detected movement of the at least one body part (3).

7. The passenger-protection unit as recited in claim 4, further comprising a distance-measuring unit (25) in the headrest (20) for distance measurements relative to the head (3) of the passenger.

8. The passenger-protection unit as recited in claim 5, further comprising a distance-measuring unit (25) in the headrest (20) for distance measurements relative to the head (3) of the passenger.

9. The passenger-protection unit as recited in claim 6, further comprising a distance-measuring unit (25) in the headrest (20) for distance measurements relative to the head (3) of the passenger.

10. The passenger-protection device as recited in claim 1, wherein the at least one sensor (11) is designed as an optical sensor, a capacitive sensor, or an ultrasonic sensor.

11. The passenger-protection device as recited in claim 2, wherein the at least one sensor (11) is designed as an optical sensor, a capacitive sensor, or an ultrasonic sensor.

12. The passenger-protection device as recited in claim 1, further comprising a filter unit assigned to the evaluation unit (5, 12) to predict the position (41) of the at least one body part (3) after a preceding position determination of the body part (3).

13. The passenger-protection device as recited in claim 2, further comprising a filter unit assigned to the evaluation unit (5, 12) to predict the position (41) of the at least one body part (3) after a preceding position determination of the body part (3).

14. The passenger-protection device as recited in claim 1, further comprising a valuation unit to evaluate the height or the weight of the passenger so as to trigger the passenger-protection unit as a function of the height or the weight of the passenger.

15. The passenger-protection device as recited in claim 14, wherein the valuation unit is assigned to the evaluation unit (12).

16. The passenger-protection device as recited in claim 2, further comprising a valuation unit to evaluate the height or the weight of the passenger so as to trigger the passenger-protection unit as a function of the height or the weight of the passenger.

17. The passenger-protection device as recited in claim 1, wherein the evaluation unit (12) suppresses an actuation of the passenger-protection unit if the sensor (11) does not detect a passenger at a position that is assigned to it.

18. The passenger-protection device as recited in claim 2, wherein the evaluation unit (12) suppresses an actuation of the passenger-protection unit if the sensor (11) does not detect a passenger at a position that is assigned to it.

19. A method for triggering a passenger-protection unit in a vehicle, comprising: detecting a movement of at least one body part of a passenger by a sensor, and evaluating the detected movement so as to trigger the passenger-protection unit as a function of the detected movement.

20. The method as recited in claim 19, wherein a headrest is triggered as a function of the movement of the passenger's head.
